(19) United States
(12) Patent Application Publication
(10) Pub. No.: US 2026/0087395 A1
(43) Pub. Date: Mar. 26, 2026

(54) System and Method for Securing Multiregional Interactions Utilizing Quantum Computing

(71) Applicant: Bank of America Corporation, Charlotte, NC (US)

(72) Inventors: Himani A. Gupta, Thane (IN); Avinash Basavant Nigudkar, Mumbai (IN); Praveen Kumar Kondabathini, Hyderabad (IN)

(21) Appl. No.: 18/895,500

(22) Filed: Sep. 25, 2024

(51) Int. Cl. G06N 10/60; G06N 10/40; H04L 9/08

(52) U.S. Cl. CPC G06N 10/60; G06N 10/40; H04L 9/0852

(57) ABSTRACT

A system includes a memory configured to store instances of a software application and a quantum processor operably coupled to the memory and configured to receive, from an instance of the software application, a user request to initiate an execution of multiregional interactions. The quantum processor is further configured to determine, based on the user request, structured data items configured to be completed by the user in order to satisfy the user request, identify, based one or more data fields within the structured data items, an input of first user identity verification data for satisfying the user request, extract, based on quantum sensor data obtained from quantum sensors, second user identity verification data, execute one or more quantum machine-learning (QML) models trained to identify whether the second user identity verification data matches to the first user identity verification data, and initiate the execution of the one or more multiregional interactions.

### TECHNICAL FIELD

The present disclosure relates generally to quantum computing, and, more specifically, to a system and method for securing multiregional interactions utilizing quantum computing.

### BACKGROUND

Certain systems may process data items stored across any number of databases and associated with any number of entities. For example, a data item may include various user data or other data that may be stored in databases associated with respective entities, and that user data or other data within the data item may be processed by any number of centralized or decentralized servers for servicing applications associated with various users. However, existing data item processing systems lack the suitable accuracy and security to be deployed at scale.

### SUMMARY

The system and methods implemented by the system as disclosed in the present disclosure provide technical solutions to the technical problems discussed above by providing systems and methods for securing multiregional interactions utilizing quantum computing. The disclosed system and methods provide several practical applications and technical advantages. Specifically, the present embodiments improve the efficiency, accuracy, speed, and security of intelligent data item processing and verification, as well as the one or more processors and memory on which the intelligent data item processing may be executed and stored by accelerating intelligent data item processing and verification utilizing quantum computing. The present embodiments provide a quantum computing system that utilizes one or more machine-learning models (e.g., one or more classical machine-learning (CML) models, one or more quantum machine-learning (QML) models, or some combination thereof) trained to identify whether first user identity verification data inputted into a know your customer (KYC) user interface (UI) and software application matches to second user identity verification data captured by one or more quantum sensors and extracted by the one or more machine-learning models.

In particular embodiments, based on whether the one or more machine-learning models (e.g., one or more classical machine-learning (CML) models, one or more quantum machine-learning (QML) models, or some combination thereof) identifies the first user identity verification data as matching to the second user identity verification data, the quantum computing system may determine whether to initiate an execution of one or more requested multiregional interactions or to forgo initiating the execution of the one or more requested multiregional interactions. In particular embodiments, the one or more machine-learning models (e.g., one or more classical machine-learning (CML) models, one or more quantum machine-learning (QML) models, or some combination thereof) may be further trained to compare one or more of the first user identity verification data or the second user identity verification data to prestored or accessible user identity verification data that may be included on one or more international sanction lists, adversarial user lists, or other similar general data protection regulation (GPDR) regulatory and compliance regimes.

Additionally, by utilizing a quantum computing system, the present embodiments may improve the efficiency, accuracy, and speed of securing and executing automated multiregional interactions and multi-entity identity verifications. Specifically, as N quantum bits (QuBits) may represent classical binary settings in 2^{N} simultaneously or in parallel, an N-QuBit quantum computing system may simultaneously explore 2^{N} possible solutions or perform 2^{N} simultaneous or parallel searches of the voluminous KYC data and historical multiregional interactions executed and stored by the quantum computing system. Specifically, in classical computing systems, two classical bits may take only one of four states: 00 or 01 or 10 or 11. Each of the first bit and the second bit combines to represent only one binary configuration at a given time in a classical computing system, and thus represents a single binary configuration. However, one QuBit may exist in multiple states simultaneously. That is, the present quantum computing system performs parallel processing to improve the efficiency, accuracy, and speed of securing and executing automated multiregional interactions and multi-entity identity verifications.

In this way, the quantum computing system increases processing speed and reduces execution time as compared to any classical computing system because the quantum computing system performs 2^{N} parallel operations to search the voluminous KYC data and historical multiregional interactions and makes a real-time or near real-time recommendation based thereon. This increased processing speed and reduced execution time further allow the quantum computing system to approve and/or reject multiregional interactions during the time in which a user has requested to be initiated a multiregional interaction and before the execution of the multiregional interaction has been completed (e.g., in real-time).

For example, in one embodiment, the quantum computing system may implement one or more quantum algorithms (e.g., Grover’s algorithm or other quantum search algorithm) to generate and return, based on the voluminous KYC data and historical multiregional interactions, a recommendation for approving or rejecting a current multiregional interaction request (e.g., a pending multiregional interaction) of a user faster than the any existing classical computing system. In particular, because the quantum computing system may, by way of entanglement and superposition, analyze voluminous KYC data and historical multiregional interactions generate recommendations based thereon by performing only one operation (or just a few operations), the quantum computing system may reduce search query execution time, such that the quantum computing system searches a database and surfaces a recommendation of whether to approve or reject a current multiregional interaction request (e.g., a pending multiregional interaction) of a user within just a few milliseconds.

The present embodiments are directed to systems and methods for securing multiregional interactions utilizing quantum computing. In particular embodiments, a system includes a memory configured to store a plurality of instances of a software application executable on a computing device. In particular embodiments, the system may further include one or more processors operably coupled to the memory and configured to receive from at least one instance of the software application executing on the computing device, a user request to initiate an execution of one or more multiregional interactions. In particular embodiments, the one or more processors may be further configured to determine, based at least in part on the user request, one or more structured data items configured to be completed by the user in order to satisfy the user request to initiate the execution of the one or more multiregional interactions.

In particular embodiments, the one or more processors may be further configured to identify, based at least in part on one or more data fields within the one or more structured data items, an input of first user identity verification data for satisfying the user request to initiate the execution of the one or more multiregional user interactions. For example, in one embodiment, the first user identity verification data may include a set of know your customer (KYC) identity verification data, in which the set of KYC identity verification data may include one or more of inventory data, regional facilities data, or multiregional interaction data.

In particular embodiments, the one or more processors may be further configured to extract, based on quantum sensor data obtained from one or more quantum sensors of the computing device, second user identity verification data associated with the user. In particular embodiments, prior to receiving the second user identity verification data associated with the user, the one or more processors may be further configured to encrypt the first user identity verification data utilizing one or more quantum encryption algorithms or one or more post-quantum cryptographic algorithms, and further to associate one or more quantum keys with the encrypted first user identity verification data to be shared between the system and the computing device.

In particular embodiments, the one or more processors may be further configured to execute one or more quantum machine-learning (QML) models trained to identify whether the second user identity verification data associated with the user matches to the first user identity verification data. In particular embodiments, in response to identifying that the second user identity verification data matches to the first user identity verification data, the one or more processors may be further configured to initiate the execution of the one or more multiregional interactions. For example, in particular embodiments, the one or more quantum machine-learning (QML) models may be trained to identify whether the second user identity verification data matches to the first user identity verification data by performing a parallel processing and comparison of each of the one or more of inventory data, regional facilities data, or multiregional interaction data to the second user identity verification data.

In particular embodiments, the memory may be further configured to store prestored user identity verification data, and the one or more processors are further configured to execute the one or more quantum machine-learning (QML) models further trained to identify whether the second user identity verification data matches to the prestored user identity verification data. In response to identifying that the second user identity verification data matches to the prestored user identity verification data, the one or more processors may be further configured to forgo the initiation of the execution of the one or more multiregional interactions.

In particular embodiments, prior to initiating the execution of the one or more multiregional interactions, the one or more processors may be further configured to execute the one or more quantum machine-learning (QML) models further trained to analyze the one or more multiregional user interactions to identify one or more potential anomalies or patterns indicative of misrepresentative data. In particular embodiments, the one or more processors may be further configured to store the second user identity verification data as one or more quantum bits (QuBits) of data to a quantum memory of the system or as one or more bits of data to a relational database of the system.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram of a combined classical computing and quantum computing system and network, in accordance with certain aspects of the present disclosure

FIG. 2 illustrates a workflow diagram of an embodiment of an intelligent data item processing and verification quantum computing system for securing multiregional interactions, in accordance with one or more embodiments of the present disclosure; and

FIG. 3 illustrates a flowchart of an example method for securing multiregional interactions utilizing quantum computing, in accordance with one or more embodiments of the present disclosure.

### DETAILED DESCRIPTION

### Example System

### System Overview

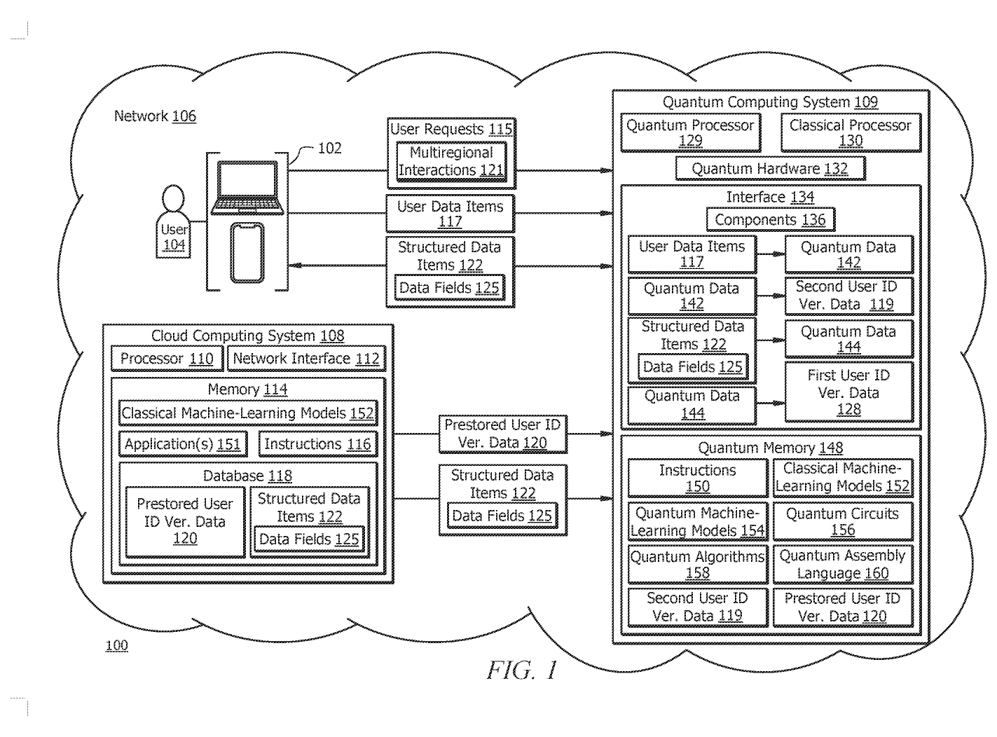

FIG. 1 is a block diagram of a combined classical computing and quantum computing system 100. As depicted, the combined classical computing and quantum computing system 100 may include one or more computing devices 102 that may be associated with a user 104, a cloud computing system 108, a quantum computing system 109, and a network 106 that enables the communications between the one or more computing devices 102, the cloud computing system 108, and the quantum computing system 109. In particular embodiments, the cloud computing system 108 and the quantum computing system 109 may be owned and managed by a single entity or organization, and thus, in some embodiments, the cloud computing system 108 and the quantum computing system 109 may operate in conjunction and/or may be integrated to operate as a singular computing infrastructure.

In another embodiment, one of the cloud computing system 108 and the quantum computing system 109 may be owned and managed by the single entity or organization while the other one of the cloud computing system 108 and the quantum computing system 109 may be owned and managed by a third-party entity or organization and licensed to be utilized by the single entity or organization. In one embodiment, the cloud computing system 108 may include a classical computing system suitable for executing binary or bitwise processing operations. In contrast, the quantum computing system 109 may include a quantum computing system suitable for executing superposed and entangled or quantum bit (QuBit) based parallel processing operations.

### Network

Network 106 may be any suitable type of wireless and/or wired network. The network 106 may or may not be connected to the Internet or public network. The network 106 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., WiFi, WiGig, WiMAX, etc.), a long-term evolution (LTE) network, a universal mobile telecommunications system (UMTS) network, a peer-to-peer (P2P) network, a Bluetooth network, a near field communication (NFC) network, and/or any other suitable network. The network 106 may be configured to support any suitable type of communication protocol as would be appreciated by one of ordinary skill in the art.

### Computing Device

Computing device 102 is generally any device that may be utilized to process data and interact with a user 104. Examples of the computing device 102 include, but are not limited to, a personal computer, a desktop computer, a workstation, a server, a laptop, a tablet computer, a mobile phone (such as a smartphone), etc. The computing device 102 may include a user interface, such as a display, a microphone, keypad, or other appropriate terminal equipment usable by the user 104. The computing device 102 may include a hardware processor, memory, and/or circuitry (not explicitly shown) configured to perform any of the functions or actions of the computing device 102 described herein. For example, a software application designed using software code may be stored in the memory and executed by the processor to perform the functions of the computing device 102. The computing device 102 may be utilized to communicate with other components of the system 100 via the network 106.

In particular embodiments, the computing device 102 may be utilized by the user 104 to communicate one or more user requests 115 to the quantum computing system 109 and/or the cloud computing system 108. For example, in one embodiment, the computing device 102 may execute an instance of a software application 151 that may be hosted and executed by the cloud computing system 108. In particular embodiments, the user 104 may access the instance of the software application 151 executing on the computing device 102 and provide one or more user requests 115 to initiate a multiregional interaction 121 to the quantum computing system 109 and/or the cloud computing system 108. As used herein, a “multiregional interaction” may refer to any interaction (e.g., transregional interactions, interactions across differing regions around the world) that may involve entities separated by long distances and/or entities that may be each operating within different contexts, such as one or more different countries, jurisdictions, states, regulatory environments, security requirements, currencies, markets, and so forth.

In particular embodiments, the user 104 may further utilize the instance of the software application 151 executing on the computing device 102 to capture and provide user data items 117 to the quantum computing system 109 and/or the cloud computing system 108. For example, in particular embodiments, the user data items 117 may include an image capture of a passport associated with the user 104, a driver’s license or a pilot’s license associated with the user 104, an employment identification (ID) card associated with the user 104, a billing invoice associated with the user 104, a birth certificate associated with the user 104, a credit card associated with the user 104, a facial image of the user 104, a fingerprint of the user 104, a body image of the user 104, one or more legal documents (e.g., requisitions, invoices, purchase orders, quotes, and so forth) associated with the user 104, or other user-provided data item that may be provided to the quantum computing system 109 and/or the cloud computing system 108.

In particular embodiments, as will be discussed in further detail below, the user data items 117 may be utilized by the quantum computing system 109 and/or the cloud computing system 108 to extract user identity verification data associated with the user 104, such as identity data associated with the user 104, income data associated with the user 104, employment data associated with the user 104, residential address data associated with the user 104, date of birth (DOB) data associated with the user 104, business ownership data associated with the user 104, billing and invoice data associated with the user 104, a tax identification data associated with the user 104, facial features of the user 104, requisitions data associated with the user 104, invoices data associated with the user 104, purchase orders data associated with the user 104, quotes data associated with the user 104, or other user identity verification data 119 that may be extracted by the quantum computing system 109 and/or the cloud computing system 108.

### Cloud Computing System

The cloud computing system 108 may include any computing system that may be utilized to process data and communicate with other components of the system 100 via the network 106. In one embodiment, the cloud computing system 108 may include a classical computing system suitable for executing binary or bitwise processing operations. As depicted, the cloud computing system 108 may include a processor 110 in signal communication with a memory 114 and a network interface 112.

Processor 110 may include one or more processors operably coupled to the memory 114. The processor 110 is any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). The processor 110 may be a programmable logic device, a microcontroller, a microprocessor, or any suitable combination of the preceding. The one or more processors 110 may be utilized to process data and may be implemented in hardware or software.

For example, the processor 110 may be an 8-bit, 16-bit, 32-bit, 64-bit, or of any other suitable architecture. The one or more processors 110 may be utilized to implement various software instructions to perform the operations described herein. For example, the one or more processors 110 may be utilized to execute software instructions 116 and perform one or more functions described herein. In one embodiment, the processor 110 may be understood to be a classical processor.

Network interface 112 may be utilized to enable wired and/or wireless communications (e.g., via network 106). The network interface 112 is utilized to communicate data between the cloud computing system 108 and other components of the system 100. For example, the network interface 112 may include a WiFi interface, a local area network (LAN) interface, a wide area network (WAN) interface, a modem, a switch, or a router. The processor 110 may be utilized to send and receive data using the network interface 112. The network interface 112 may utilize any suitable type of communication protocol as would be appreciated by one of ordinary skill in the art.

Memory 114 may be volatile or non-volatile and may include a read-only memory (ROM), random-access memory (RAM), ternary content-addressable memory (TCAM), dynamic random-access memory (DRAM), and static random-access memory (SRAM). Memory 114 may be implemented using one or more disks, tape drives, solid-state drives, and/or the like. The memory 114 may store any of the information described in FIGS. 1-3 along with any other data, instructions, logic, rules, or code operable to implement the function(s) described herein. The memory 114 is operable to store software instructions 116, and/or any other data and instructions. The software instructions 116 may include any suitable set of software instructions, logic, rules, or code operable to be executed by the processor 110. In particular embodiments, the memory 114 may further store a database 118, which may include a structured data base (e.g., structured query language (SQL) database, a non-SQL database, or other similar relational database), an unstructured database, a sorted data structure, or an unsorted structure. In one embodiment, the memory 114 may be understood to be a classical memory. In one embodiment, the memory 114 may include a non-transitory computer-readable medium.

In particular embodiments, the database 118 may store prestored or accessible user identity verification data 120 and structured data items 122. In particular embodiments, the prestored or accessible user identity verification data 120 may include, for example, one or more lists of adversarial users, such as an international sanction list, an adversarial user list, a no-fly list, a non-contact list, or other similar general data protection regulation (GPDR) regulatory and compliance regime that may be suitable for identifying adversarial users that may potentially attack or infiltrate multiregional interactions 121.

In particular embodiments, the structured data items 122 may include any data item that includes a standardize format and one or more standardized data fields 125 into which user data may be inputted. For example, in one embodiment, the structured data items 122 may include for example, an electronic form, an electronic document, an electronic billing invoice, an electronic purchase order, an electronic tax form, an electronic employment application, an electronic credit application, an electronic receipt, an electronic requisition, or other similar structured data item including one or more data fields 125 into which suitable or routine user data associated with multiregional interactions 121 may be inputted.

### Quantum Computing System

The quantum computing system 109 may include any quantum computing system that may be utilized to process data and communicate with other components of the system 100 via the network 106. In one embodiment, the quantum computing system 109 may include a quantum computing system suitable for executing superposed and entangled or quantum bit (QuBit) based parallel processing operations. As depicted, the quantum computing system 109 may include a quantum processor 129, a classical processor 130, and an interface 134 in signal communication with a quantum memory 148.

The quantum processor 129 may include one or more quantum processors operably coupled to the quantum memory 148. The quantum processor 129 may be utilized to process quantum bits (QuBits). The quantum processor 129 may include a superconducting quantum device (with QuBits implemented by states of Josephson junctions), a trapped ion device (with QuBits implemented by internal states of trapped ions), a trapped neutral atom device (with QuBits implemented by internal states of trapped neutral atoms), a photon-based device (with QuBits implemented by modes of photons), or any other suitable device that implements QuBits with states of a respective quantum system. In particular embodiments, the quantum processor 129 may be a quantum processing unit (QPU), which may include a number of quantum registers, a dedicated quantum memory, and a number of quantum logic gates (e.g., a quantum logic gate, a Hadamard logic gate, a Pauli-X logic gate, a Pauli-Y logic gate, a Pauli-Z logic gate, a controlled NOT logic gate, and so forth) suitable for executing superposed and entangled or quantum bit (QuBit) based parallel processing operations.

In particular embodiments, the quantum processor 129 may be further utilized to perform quantum computations, such as quantum annealing, quantum simulations, and universal quantum computing. For example, in particular embodiments, the quantum processor 129 may, in conjunction with the quantum memory 148 and utilizing the quantum hardware 132, execute one or more classical machine-learning (CML) models 152, one or more quantum machine-learning (QML) models 154, one or more quantum circuits 156, one or more quantum algorithms 158, and/or one or more quantum assembly languages 160 for performing operations on one or more of the second user identity verification data 119, user identity verification data 128, and/or the prestored user identity verification data 120.

In particular embodiments, the one or more classical machine-learning (CML) models 152 may include, for example, one or more of a spiking neural network (SNN), an autoencoder (AE), a variational autoencoder (VAE), a generative adversarial network (GAN), a convolutional neural network (CNN), a deep neural network (DNN), a deep convolutional neural network (DCNN), a graph neural network (GNN), a graph convolutional network (GCN), a bidirectional and auto-regressive transformer (BART) model, a bidirectional encoder representations for transformer (BERT) model, a generative pre-trained transformer (GPT) model, a graph transformer, or other similar machine-learning model. Similarly, in particular embodiments, the one or more quantum machine-learning (QML) models 154 may include one or more of a quantum-enhanced machine-learning model, a quantum-inspired machine-learning model, a quantum-generalized machine-learning model, or any of various other machine-learning models in which the processing power of quantum computing and the properties of quantum physics are utilized to accelerate machine-learning tasks.

Specifically, it should be appreciated that the quantum computing system 109 may be capable of executing both the one or more classical machine-learning (CML) models 152 and the one or more quantum machine-learning (QML) models 154 in accordance with the presently disclosed embodiments. On the other hand, the cloud computing system 108 may be capable of executing only the one or more classical machine-learning (CML) models 152.

In particular embodiments, the quantum hardware 132 may include, for example, a number of quantum bits (QuBits), a number of QuBit connectors, a number of QuBit interconnector circuits for control operations, and a quantum random access memory (QRAM). The one or more quantum circuits 156 may include a sequence of quantum logic gates suitable for representing and expressing each step of the one or more one or more quantum algorithms 158. For example, in one embodiment, the one or more quantum algorithms 158 may include any of various quantum algorithms, such as quantum annealing algorithms, quantum simulation algorithms, quantum search algorithms (e.g., Grover’s algorithm), quantum cryptography algorithms (e.g., Shor’s algorithm), one or more quantum Fourier transform (QFT) based algorithms or inverse quantum Fourier transform (iQFT) based algorithms, one or more classical quantum hybrid algorithms (e.g., Quantum Eigensolver), one or more classical quantum variational algorithms, and/or other user-developed quantum algorithms that may be represented by instructions 150. In another embodiment, the one or more one or more quantum algorithms 158 may include one or more post-quantum cryptographic algorithms (e.g., quantum-resistant encryption algorithms) and/or other post-quantum algorithms.

The classical processor 130 may include one or more processors operably coupled to the quantum memory 148. The classical processor 130 is any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). The classical processor 130 may be a programmable logic device, a microcontroller, a microprocessor, or any suitable combination of the preceding. The one or more processors are configured to process data and may be implemented in hardware or software. For example, the classical processor 130 may be 8-bit, 16-bit, 32-bit, 64-bit, or of any other suitable architecture. The one or more processors are configured to implement various software instructions to perform the operations described herein.

The interface 134 may be utilized to convert data items represented by classical binary bits of data into to quantum bits (QuBits) of data. For example, in particular embodiments, the interface 134 may convert user data items 117 represented as classical binary bits of data into quantum data 142 for inputting into one or more QML models 154, and, similarly, convert structured data items 122 represented as classical binary bits of data into quantum data 144 for inputting into one or more QML models 154, for example. In particular embodiments, the interface 134 may be further utilized to convert data items represented by quantum bits (QuBits) of data into classical binary bits of data.

For example, in particular embodiments, upon the quantum computing system 109 extracting user identity verification data from the user data items 117 based on the quantum data 142, the interface 134 may convert the quantum data 142 representing the second user identity verification data 119 into classical binary bits of data representing the quantum data 142 representing the second user identity verification data 119. Likewise, upon the quantum computing system 109 identifying suitable user information inputted into identified data fields 125 of the structured data items 122 based on the quantum data 144, the interface 134 may convert the quantum data 144 representing the structured data items 122 into classical binary bits of data representing the first user identity verification data 128.

In particular embodiments, the interface 134 may include a number of components 136 that may be utilized to generate and manipulate quantum bits (QuBits. In the illustrated embodiment, the number of components 136 and the quantum processor 129 may be utilized to operate on a same type of quantum bits (QuBits). For example, when the quantum processor 129 includes a photon-based device (with QuBits implemented by modes of photons), the number of components 136 may include optical components such as lasers, mirrors, prisms, waveguides, interferometers, optical fibers, filters, polarizers, and/or lenses.

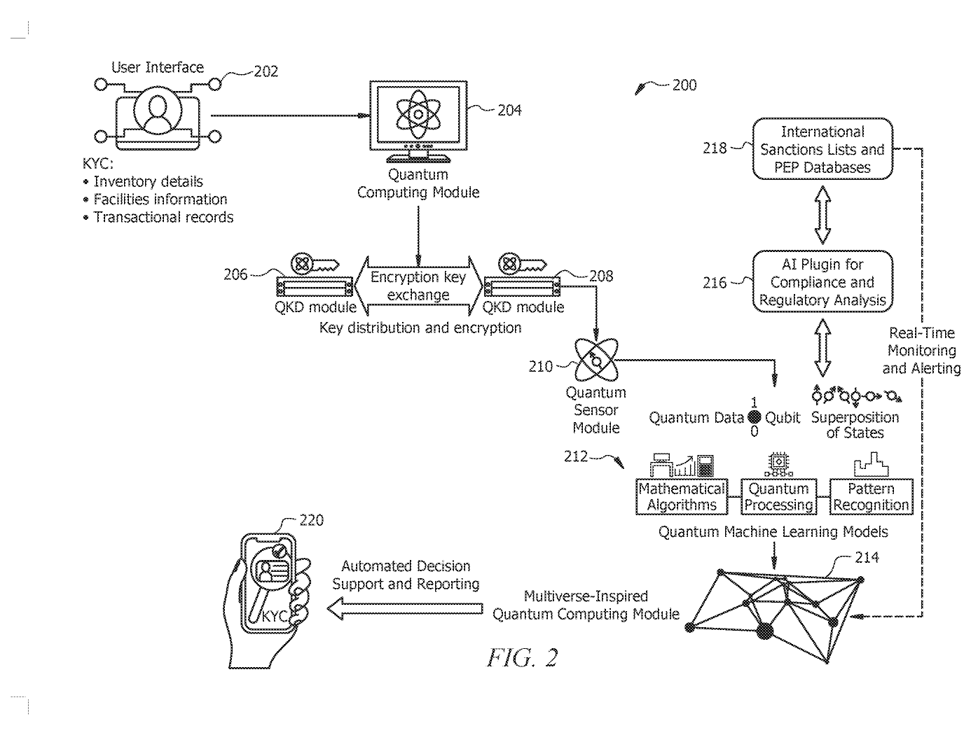

Quantum memory 148 may include a quantum read-only memory (QROM), quantum random-access memory (QRAM), or other similar quantum memory. The quantum memory 148 may store any of the information described in FIGS. 1 and 2 along with any other data, instructions, logic, rules, or code operable to implement the function(s) described herein. The quantum memory 148 is operable to store software instructions 150, and/or any other data and instructions. The software instructions 150 may include any suitable set of software instructions, logic, rules, or code operable to be executed by the quantum processor 129. In one embodiment, the quantum memory 148 may include a non-transitory computer-readable medium.

### Securing multiregional interactions utilizing quantum computing

Embodiments of the present disclosure discuss techniques for securing multiregional interactions utilizing quantum computing.

FIG. 2 illustrates a workflow diagram of an embodiment of an intelligent data item processing and verification quantum computing system 200 for securing multiregional interactions, in accordance with certain aspects of the present disclosure. In particular embodiments, the workflow of the intelligent data item processing and verification quantum computing system 200 may be performed utilizing the combined classical computing and quantum computing system 100 as described above with respect to FIG. 1. As depicted, the workflow of the intelligent data item processing and verification quantum computing system 200 may begin with a user (e.g., the user 104) accessing a user interface (UI) 202 of an instance of a software application that may be executing on a computing device, such as the computing device 102. For example, in one embodiment, the user (e.g., the user 104) may utilize the UI 202 to make a user request to initiate an execution of one or more multiregional interactions 121.

In particular embodiments, the UI 202 may include one or more UIs of an instance of a software application that may be suitable for executing and securing one or more multiregional interactions between the user (e.g., the user 104) and an entity that may be responsible for facilitating the one or more multiregional interactions 121. For example, in one embodiment, a “multiregional interaction” may refer to any interaction (e.g., transregional interactions, interactions across differing regions around the world) that may involve entities separated by long distances and/or entities that may be each operating within different contexts, such as one or more different countries, jurisdictions, states, regulatory environments, security requirements, currencies, markets, and so forth.

In particular embodiments, as further depicted by FIG. 2, as part of the user request to initiate an execution of one or more multiregional interactions 121, the workflow of the intelligent data item processing and verification quantum computing system 200 may continue with the user (e.g., the user 104) being prompted to input first user identity verification data 128. For example, in particular embodiments, the first user identity verification data 128 inputted by the user (e.g., the user 104) may include a set of know your customer (KYC) identity verification data that may be associated with multiregional interactions 121, such as one or more of inventory data (e.g., line-item data, a price of a product or service, a quantity of a product or service, a unit of measure (UOM) with respect to a product or service, total volume of products and services produced, and so forth), regional facilities data (e.g., port size, total volume of shipping containers, total number of shipping containers, facility capacity, and so forth), or multiregional interaction data (e.g., requisitions data, invoices data, purchase orders data, price quotes data, sourcing events data, and so forth).

In particular embodiments, upon the user (e.g., the user 104) inputting the first user identity verification data 128 (e.g., user inputted KYC identity verification data), the workflow of the intelligent data item processing and verification quantum computing system 200 may continue with the user request and the first user identity verification data 128 (e.g., KYC identity verification data) being provided to a quantum computing module 204. In particular embodiments, the quantum computing module 204 may be identical to the quantum computing system 109 as described above with respect to FIG. 1.

In particular embodiments, upon the quantum computing module 204 receiving the user request and the first user identity verification data 128 (e.g., user inputted KYC identity verification data), the workflow of the intelligent data item processing and verification quantum computing system 200 may continue with the quantum computing module 204 encrypting the first user identity verification data 128 utilizing one or more post-quantum cryptographic algorithms (e.g., quantum-resistant encryption algorithms) and providing the encrypted first user identity verification data 128 to a quantum key distribution (QKD) module 206.

In particular embodiments, the QKD module 206 may be implemented utilizing, for example, the quantum processor 129, the quantum hardware 132, and the quantum memory 148 as each described above with respect to FIG. 1. In particular embodiments, upon the QKD module 206 receiving the encrypted first user identity verification data 128 (e.g., encrypted KYC identity verification data), the workflow of the intelligent data item processing and verification quantum computing system 200 may continue with the QKD module 206 distributing one or more quantum-safe encryption keys between the QKD module 206 and a QKD module 208 to be associated with the encrypted first user identity verification data 128 (e.g., encrypted KYC identity verification data). It should be appreciated that the QKD module 208 is included merely for the purposes of illustration. In accordance with the presently disclosed embodiments, the QKD module 208 may be associated with the computing device 102, and thus the QKD module 206 share the one or more quantum-safe encryption keys between the QKD module 206 and the computing device 102, for example.

In particular embodiments, upon distributing the one or more quantum-safe encryption keys between the QKD module 206 and the QKD module 208, the workflow of the intelligent data item processing and verification quantum computing system 200 may continue with the quantum computing module 204 requesting the user (e.g., user 104) to provide second user identity verification data 119. For example, in one embodiment, the quantum computing module 204 may request the user (e.g., user 104) to provide a representative image of one or more legal documents (e.g., requisitions, invoices, purchase orders, quotes, and so forth) for substantiating and verifying the first user identity verification data 128 (e.g., user inputted KYC identity verification data).

In particular embodiments, upon receiving the second user identity verification data 119 (e.g., requisitions, invoices, purchase orders, quotes, and so forth), the workflow of the intelligent data item processing and verification quantum computing system 200 may continue with the quantum sensor module 210 extracting, based on quantum sensor data obtained from one or more quantum sensors (e.g., photon detectors, single-photon detectors) of the computing device 102, the second user identity verification data 119 (e.g., requisitions, invoices, purchase orders, quotes, and so forth). In particular embodiments, the quantum sensor module 210 may be included as part of the quantum hardware 132 as described above with respect to FIG. 1.

In particular embodiments, upon the quantum sensor module 210 extracting, based on the quantum sensor data, the second user identity verification data 119 (e.g., requisitions, invoices, purchase orders, quotes, and so forth), the workflow of the intelligent data item processing and verification quantum computing system 200 may continue with executing one or more quantum machine-learning (QML) models 212 to identify whether the second user identity verification data 119 (e.g., requisitions, invoices, purchase orders, quotes, and so forth) matches to the first user identity verification data 128 (e.g., user inputted KYC identity verification data) for verifying the first user identity verification data 128 (e.g., user inputted KYC identity verification data). For example, in particular embodiments, the quantum sensor module 210 may be included as part of the quantum hardware 132 as described above with respect to FIG. 1.

In particular embodiments, the one or more quantum machine-learning (QML) models 212 may further analyze the first user identity verification data 128 (e.g., user inputted KYC identity verification data) to identify one or more potential anomalies or patterns indicative of misrepresentative data. For example, in one embodiment, the one or more quantum machine-learning (QML) models 212 may include a quantum computing based optical character recognition (OCR) engine that may be suitable for detecting and extracting text characters included in the second user identity verification data 119 (e.g., requisitions, invoices, purchase orders, quotes, and so forth) for comparison against the first user identity verification data 128 (e.g., user inputted KYC identity verification data). In particular embodiments, the one or more quantum machine-learning (QML) models 212 may be identical to the one or more quantum machine-learning (QML) models 154 as described above with respect to FIG. 1.

In particular embodiments, the one or more quantum machine-learning (QML) models 212 may be executed in conjunction with an artificial intelligence (AI) plugin 216 and multiverse-inspired quantum computing module 214. For example, in particular embodiments, the workflow of the intelligent data item processing and verification quantum computing system 200 may include executing one or more quantum machine-learning (QML) models 212 in conjunction with the multiverse-inspired quantum computing module 214 to identify whether the second user identity verification data 119 (e.g., requisitions, invoices, purchase orders, quotes, and so forth) matches to the first user identity verification data 128 (e.g., user inputted KYC identity verification data).

In particular embodiments, the one or more quantum machine-learning (QML) models 212 may be executed in conjunction with the multiverse-inspired quantum computing module 214 to perform a parallel processing and comparison (e.g., based on the “superposition” principle of quantum computing that subatomic particles or photons exist at any time in more than one state simultaneously) of each of the one or more of inventory data, regional facilities data, or multiregional interaction data to the second user identity verification data 119. That is, each of the one or more of inventory data, regional facilities data, or multiregional interaction data may be compared to the second user identity verification data 119 in parallel, but each as separate and distinct Qubits existing in multiple states or “universes” simultaneously. This increases the accuracy and granularity of the overall comparison and verification.

In particular embodiments, upon identifying whether the second user identity verification data 119 (e.g., requisitions, invoices, purchase orders, quotes, and so forth) matches to the first user identity verification data 128 (e.g., user inputted KYC identity verification data), the workflow of the intelligent data item processing and verification quantum computing system 200 may continue with executing the one or more quantum machine-learning (QML) models 212 in conjunction with the AI plugin 216 to compare the second user identity verification data 119 (e.g., requisitions, invoices, purchase orders, quotes, and so forth) to the prestored user identity verification data 120.

For example, in particular embodiments, the prestored user identity verification data 120 may include one or more lists 218 (e.g., international sanction lists, adversarial user lists, or other similar general data protection regulation (GPDR) regulatory and compliance regimes) by which the second user identity verification data 119 (e.g., requisitions, invoices, purchase orders, quotes, and so forth) may be compared. In one embodiment, the AI plugin 216 may monitor and receive real-time or near real-time updates to the one or more lists 218 and/or generate one or more alerts in response to updates to the one or more lists 218.

In particular embodiments, upon identifying that the second user identity verification data 119 (e.g., requisitions, invoices, purchase orders, quotes, and so forth) matches to the first user identity verification data 128 (e.g., user inputted KYC identity verification data), and further that the second user identity verification data 119 (e.g., requisitions, invoices, purchase orders, quotes, and so forth) does not match to the one or more lists 218, the workflow of the intelligent data item processing and verification quantum computing system 200 may conclude with satisfying the user request to initiate the execution of one or more multiregional interactions 121.

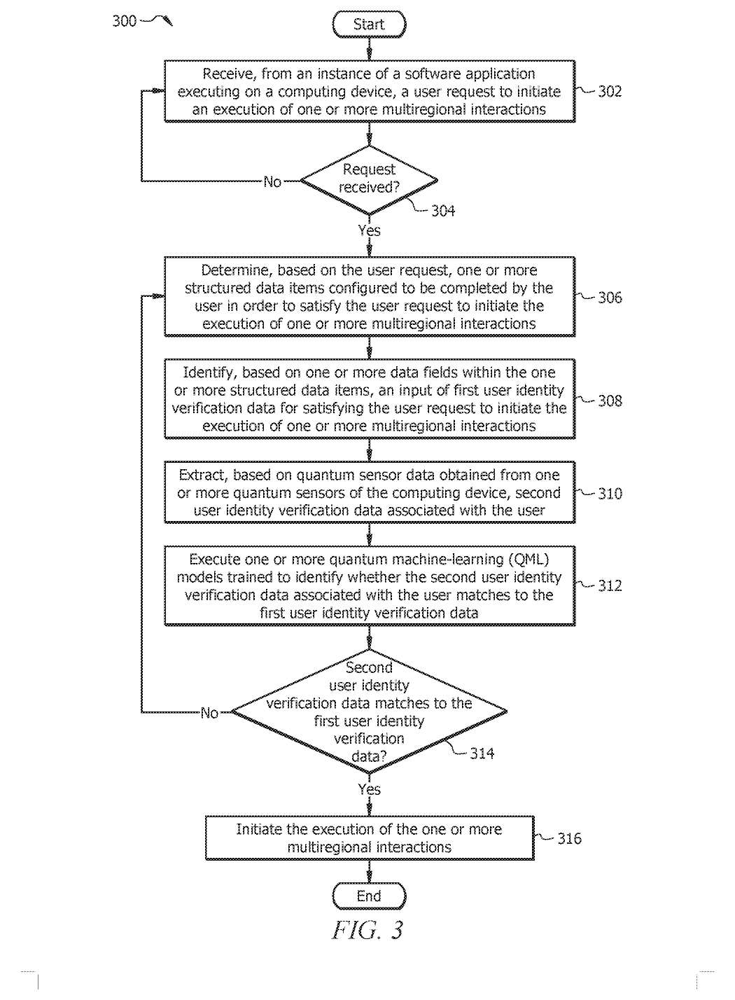

FIG. 3 illustrates a flowchart of an example method 300 for securing multiregional interactions utilizing quantum computing, in accordance with one or more embodiments of the present disclosure. The method 300 may be performed by the combined classical computing and quantum computing system 100 as described above with respect to FIG. 1. For example, in one embodiment, the method 300 may be performed by the quantum computing system 109 alone. In yet another embodiment, the method 300 may be performed in conjunction by the cloud computing system 108 and the quantum computing system 109.

The method 300 may begin at block 302 with the quantum computing system 109 receiving from an instance of a software application executing on a computing device, a user request to initiate an execution of one or more multiregional interactions. For example, in one embodiment, the user (e.g., the user 104) may utilize the UI 202 to make a user request to initiate an execution of one or more multiregional interactions 121. In particular embodiments, the method 300 may continue at decision 304 with the quantum computing system 109 confirming whether the user request to initiate an execution of one or more multiregional interactions has been received. In particular embodiments, in response to determining that the user request to initiate an execution of one or more multiregional interactions has not been received (e.g., at decision 304), the method 300 may return to block 302.

On the other hand, in response to determining that the user request to initiate an execution of one or more multiregional interactions has been received (e.g., at decision 304), the method 300 may continue at block 306 with the quantum computing system 109 determining, based on the user request, one or more structured data items configured to be completed by the user in order to satisfy the user request to initiate the execution of one or more multiregional interactions. For example, in one embodiment, the user (e.g., the user 104) may be prompted to input first user identity verification data 128 into one or more data fields 125 of structured data items 122.

In particular embodiments, the method 300 may continue at block 308 with the quantum computing system 109 identifying, based on one or more data fields within the one or more structured data items, an input of first user identity verification data for satisfying the user request to initiate the execution of one or more multiregional interactions. For example, in particular embodiments, the first user identity verification data 128 inputted by the user (e.g., the user 104) may include a set of KYC identity verification data that may be associated with multiregional interactions 121, such as one or more of inventory data, regional facilities data, or multiregional interaction data.

In particular embodiments, the method 300 may continue at block 310 with the quantum computing system 109 extracting, based on quantum sensor data obtained from one or more quantum sensors of the computing device, second user identity verification data associated with the user. For example, in particular embodiments, the quantum computing system 109 may extract, based on quantum sensor data obtained from one or more quantum sensors (e.g., photon detectors, single-photon detectors) of the computing device 102, the second user identity verification data 119 (e.g., requisitions, invoices, purchase orders, quotes, and so forth).

In particular embodiments, the method 300 may continue at block 312 with the quantum computing system 109 executing one or more quantum machine-learning (QML) models trained to identify whether the second user identity verification data matches to the first user identity verification data. For example, in one embodiment, the one or more quantum machine-learning (QML) models 212 may include a quantum computing based OCR engine that may be suitable for detecting and extracting text characters included in the second user identity verification data 119 (e.g., requisitions, invoices, purchase orders, quotes, and so forth) for comparison against the first user identity verification data 128 (e.g., user inputted KYC identity verification data).

In particular embodiments, the method 300 may continue at decision 314 with the quantum computing system 109 confirming whether the second user identity verification data matches to the first user identity verification data. In particular embodiments, in response to determining that the second user identity verification data does not match to the first user identity verification data (e.g., at decision 314), the method 300 may return to block 306. On the other hand, in response to determining that the second user identity verification data matches to the first user identity verification data (e.g., at decision 314), the method 300 may conclude at block 316 with the quantum computing system 109 initiating the execution of the one or more multiregional interactions to satisfy the user request.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system, comprising:
a memory configured to store a plurality of instances of a software application executable on a computing device; and
one or more quantum processors operably coupled to the memory and configured to:
receive, from at least one instance of the software application executing on the computing device, a user request to initiate an execution of one or more multiregional interactions, and, in response:
determine, based at least in part on the user request, one or more structured data items configured to be completed by the user in order to satisfy the user request to initiate the execution of the one or more multiregional interactions;
identify, based at least in part on one or more data fields within the one or more structured data items, an input of first user identity verification data for satisfying the user request to initiate the execution of the one or more multiregional user interactions;
extract, based on quantum sensor data obtained from one or more quantum sensors of the computing device, second user identity verification data;
execute one or more quantum machine-learning (QML) models trained to identify whether the second user identity verification data matches to the first user identity verification data; and
in response to identifying that the second user identity verification data matches to the first user identity verification data, initiate the execution of the one or more multiregional interactions.

2. The system of claim 1, wherein the memory is further configured to store prestored user identity verification data, and wherein the one or more quantum processors are further configured to:
execute the one or more quantum machine-learning (QML) models further trained to identify whether the second user identity verification data matches to the prestored user identity verification data; and
in response to identifying that the second user identity verification data matches to the prestored user identity verification data, forgo the initiation of the execution of the one or more multiregional interactions.

3. The system of claim 1, wherein the first user identity verification data comprises a set of know your customer (KYC) identity verification data, and wherein the set of KYC identity verification data comprises one or more of inventory data, regional facilities data, or multiregional interaction data.

4. The system of claim 3, wherein the one or more quantum processors are further configured to execute the one or more quantum machine-learning (QML) models further trained to identify whether the second user identity verification data matches to the first user identity verification data by performing a parallel processing and comparison of each of the one or more of inventory data, regional facilities data, or multiregional interaction data to the second user identity verification data.

5. The system of claim 1, wherein the one or more quantum processors are further configured to:
prior to receiving the second user identity verification data:
encrypt the first user identity verification data utilizing one or more quantum encryption algorithms or one or more post-quantum cryptographic algorithms; and
associate one or more quantum keys with the encrypted first user identity verification data to be shared between the system and the computing device.

6. The system of claim 1, wherein the one or more quantum processors are further configured to:
prior to initiating the execution of the one or more multiregional interactions, execute the one or more quantum machine-learning (QML) models further trained to analyze the one or more multiregional user interactions to identify one or more potential anomalies or patterns indicative of misrepresentative data.

7. The system of claim 1, wherein the one or more quantum processors are further configured to store the second user identity verification data as one or more quantum bits (QuBits) of data to a quantum memory of the system or as one or more bits of data to a relational database of the system.

8. A method, comprising:
receiving, from at least one instance of a software application executing on a computing device, a user request to initiate an execution of one or more multiregional interactions, and, in response:
determining, based at least in part on the user request, one or more structured data items configured to be completed by the user in order to satisfy the user request to initiate the execution of the one or more multiregional interactions;
identifying, based at least in part on one or more data fields within the one or more structured data items, an input of first user identity verification data for satisfying the user request to initiate the execution of the one or more multiregional user interactions;
extracting, based on quantum sensor data obtained from one or more quantum sensors of the computing device, second user identity verification data;
executing one or more quantum machine-learning (QML) models trained to identify whether the second user identity verification data matches to the first user identity verification data; and
in response to identifying that the second user identity verification data matches to the first user identity verification data, initiating the execution of the one or more multiregional interactions.

9. The method of claim 8, further comprising:
executing the one or more quantum machine-learning (QML) models further trained to identify whether the second user identity verification data matches to prestored user identity verification data; and
in response to identifying that the second user identity verification data matches to the prestored user identity verification data, forgoing the initiation of the execution of the one or more multiregional interactions.

10. The method of claim 8, wherein the first user identity verification data comprises a set of know your customer (KYC) identity verification data, and wherein the set of KYC identity verification data comprises one or more of inventory data, regional facilities data, or multiregional interaction data.

11. The method of claim 10, wherein identifying whether the second user identity verification data matches to the first user identity verification data further comprises performing a parallel processing and comparison of each of the one or more of inventory data, regional facilities data, or multiregional interaction data to the second user identity verification data.

12. The method of claim 8, further comprising:
prior to receiving the second user identity verification data:
encrypting the first user identity verification data utilizing one or more quantum encryption algorithms or one or more post-quantum cryptographic algorithms; and
associating one or more quantum keys with the encrypted first user identity verification data to be shared between a system and the computing device.

13. The method of claim 8, further comprising:
prior to initiating the execution of the one or more multiregional interactions, executing the one or more quantum machine-learning (QML) models further trained to analyze the one or more multiregional user interactions to identify one or more potential anomalies or patterns indicative of misrepresentative data.

14. The method of claim 8, further comprising storing the second user identity verification data as one or more quantum bits (QuBits) of data to a quantum memory of a system or as one or more bits of data to a relational database of the system.

15. A non-transitory computer-readable medium storing instructions that, when executed by one or more quantum processors, cause the one or more quantum processors to:
receive, from at least one instance of a software application executing on a computing device, a user request to initiate an execution of one or more multiregional interactions, and, in response:
determine, based at least in part on the user request, one or more structured data items configured to be completed by the user in order to satisfy the user request to initiate the execution of the one or more multiregional interactions;
identify, based at least in part on one or more data fields within the one or more structured data items, an input of first user identity verification data for satisfying the user request to initiate the execution of the one or more multiregional user interactions;
extract, based on quantum sensor data obtained from one or more quantum sensors of the computing device, second user identity verification data;
execute one or more quantum machine-learning (QML) models trained to identify whether the second user identity verification data matches to the first user identity verification data; and
in response to identifying that the second user identity verification data matches to the first user identity verification data, initiate the execution of the one or more multiregional interactions.

16. The non-transitory computer-readable medium of claim 15, wherein the instructions further cause the one or more quantum processors to:
execute the one or more quantum machine-learning (QML) models further trained to identify whether the second user identity verification data matches to prestored user identity verification data; and
in response to identifying that the second user identity verification data matches to the prestored user identity verification data, forgo the initiation of the execution of the one or more multiregional interactions.

17. The non-transitory computer-readable medium of claim 15, wherein the first user identity verification data comprises a set of know your customer (KYC) identity verification data, and wherein the set of KYC identity verification data comprises one or more of inventory data, regional facilities data, or multiregional interaction data.

18. The non-transitory computer-readable medium of claim 17, wherein the instructions further cause the one or more quantum processors to:
execute the one or more quantum machine-learning (QML) models further trained to identify whether the second user identity verification data matches to the first user identity verification data by performing a parallel processing and comparison of each of the one or more of inventory data, regional facilities data, or multiregional interaction data to the second user identity verification data.

19. The non-transitory computer-readable medium of claim 15, wherein the instructions further cause the one or more quantum processors to:
prior to receiving the second user identity verification data:
encrypt the first user identity verification data utilizing one or more quantum encryption algorithms or one or more post-quantum cryptographic algorithms; and
associate one or more quantum keys with the encrypted first user identity verification data to be shared between a system and the computing device.

20. The non-transitory computer-readable medium of claim 15, wherein the instructions further cause the one or more quantum processors to:
prior to initiating the execution of the one or more multiregional interactions, execute the one or more quantum machine-learning (QML) models further trained to analyze the one or more multiregional user interactions to identify one or more potential anomalies or patterns indicative of misrepresentative data.
